(19) United States
(12) Patent Application Publication
(10) Pub. No.: US 2026/0064496 A1
(43) Pub. Date: Mar. 5, 2026

(54) SYSTEM AND METHOD FOR PROCESSING AND MANAGING DIGITAL OBJECTS FOR DIGITAL WALLETS

(71) Applicant: MASTERCARD ASIA/PACIFIC PTE. LTD., SINGAPORE (SG)

(72) Inventors: Elijah Goh Xin YAO, Singapore (SG); Mei Ting LEONG, Singapore (SG); Wilianto WU, Singapore (SG)

(21) Appl. No.: 19/313,538

(22) Filed: Aug. 28, 2025

(30) Foreign Application Priority Data
Aug. 29, 2024 (SG) 10202402670X

(51) Int. Cl. G06F 9/54; G06Q 20/36

(52) U.S. Cl. CPC G06F 9/54; G06Q 20/367

(57) ABSTRACT

Systems and methods which format and route digital objects for digital wallet environments are described. A method for managing digital objects comprises: receiving, by a processor, a wallet capability configuration corresponding to one or more capabilities that are compatible with a digital wallet; receiving, by the processor, user data comprising a token identifier, a wallet identifier, and one or more digital objects associated with the token identifier and the wallet identifier; formatting, by the processor, the received one or more digital objects for compatibility with the digital wallet based on the wallet capability configuration to generate one or more formatted digital objects; and routing, by the processor, the one or more formatted digital objects to the digital wallet according to a routing configuration, wherein the routing configuration uses at least the token identifier for determining the digital wallet as a destination wallet for routing the formatted digital object(s).

### CROSS-REFERENCE TO RELATED APPLICATION

This application claims the benefit of, and priority to, Singapore Patent Application No. 10202402670X filed on Aug. 29, 2024. The entire disclosure of the above application is incorporated herein by reference.

### FIELD

The present disclosure relates to methods and systems for processing and managing digital objects for digital wallet environments, specifically the formatting and routing of digital objects based on wallet capability and routing configurations.

### BACKGROUND

This section provides background information related to the present disclosure which is not necessarily prior art.

Digital wallet technologies have been pivotal in streamlining electronic transactions, yet they often rely on static visual elements to represent payment credentials, potentially limiting user engagement. Traditionally, digital wallet interfaces have provided limited interactivity, focusing on transactional efficiency and security, rather than on a dynamic or personalized user experience. Consequently, the potential for interactive user engagement—responsive to contextual inputs or user behaviour—has been underutilized in these platforms. Moreover, existing systems do not adequately support the management and customization of varied digital content across a range of digital wallet environments.

### SUMMARY

This section provides a general summary of the disclosure, and is not a comprehensive disclosure of its full scope or all of its features. Aspects and embodiments of the disclosure are set out in the accompanying claims.

In accordance with a first aspect of the present disclosure, a digital object management system is provided. The system comprises: a processor, and a data storage device, the data storage device storing computer program instructions operable to cause the processor to: receive a wallet capability configuration corresponding to one or more capabilities that are compatible with a digital wallet; receive user data comprising a token identifier, a wallet identifier, and one or more digital objects associated with the token identifier and the wallet identifier; format the received one or more digital objects for compatibility with the digital wallet based on the wallet capability configuration to generate one or more formatted digital objects; and route the one or more formatted digital objects to the digital wallet according to a routing configuration, wherein the routing configuration uses at least the token identifier for determining the digital wallet as a destination wallet for routing the one or more formatted digital objects.

The digital object may include at least one of a video file, an image, an audio file, a haptic feedback script, or an interactive script.

In an embodiment, data storage device further stores instructions operable to cause the processor to enable a system administrator to update or modify the routing configuration or the wallet capability configuration through an API interface module.

In an embodiment, the data storage device further stores instructions operable to cause the processor to enable a retrieval of a plurality of digital objects associated with the user data based on a user's wallet identifier and token identifier, and to update a digital object status corresponding to each of the retrieved digital objects.

In an embodiment, the data storage device further stores instructions operable to cause the processor to receive and store a plurality of digital objects uploaded by a cardholder through an issuer interface, wherein each of the plurality of digital objects is associated with a token identifier, a wallet identifier, and a digital object identifier.

In an embodiment, the data storage device further stores instructions operable to cause the processor to dynamically update the routing configuration based on the changes to the one or more features corresponding to the wallet capability configuration.

In an embodiment, the wallet capability configuration supports at least one of an image, video, audio, interaction script, or haptic format.

In an embodiment, the data storage device further stores instructions operable to cause the processor to receive, from the digital wallet, a set configuration request via an API interface, wherein a wallet identifier and a wallet configuration are requested for initialization by the digital wallet.

In an embodiment, the data storage device further stores instructions operable to cause the processor to receive, from the digital wallet, an update configuration request via an API interface, wherein a wallet identifier and a wallet configuration are requested for updating by the digital wallet.

In an embodiment, the data storage device further stores instructions operable to cause the processor to receive, from an issuer, a read request via an API interface, wherein a wallet identifier and a token identifier are requested for reading by the issuer.

In an embodiment, the data storage device further stores instructions operable to cause the processor to receive, from an issuer, an update request via an API interface, wherein a digital object identifier is requested for updating by the issuer.

In an embodiment, the data storage device further stores instructions operable to cause the processor to receive, from an issuer, a delete request via an API interface, wherein a digital object identifier is requested for deletion by the issuer.

In an embodiment, the data storage device further stores instructions operable to cause the processor to receive, from an issuer, an upload request via an API interface, wherein a digital object and its corresponding wallet identifier and token identifier are requested for upload by the issuer.

In an embodiment, the data storage device further stores instructions operable to cause the processor to execute a push notification via an API interface for pushing the one or more formatted digital objects and associated token identifier to the digital wallet.

In an embodiment, the data storage device further stores instructions operable to cause the processor to receive, from the digital wallet, a read request via an API interface for retrieving the digital object and a corresponding digital object status.

In an embodiment, the data storage device further stores instructions operable to cause the processor to receive, from the digital wallet, an update request via an API interface, wherein the update request corresponds to an update to a digital object status.

According to a second aspect of the present disclosure, a method for managing digital objects is provided. The method for managing digital objects comprises: receiving, by a processor, a wallet capability configuration corresponding to one or more capabilities that are compatible with a digital wallet; receiving, by the processor, user data comprising a token identifier, and a wallet identifier, and one or more digital objects associated with the token identifier and the wallet identifier; formatting, by the processor, the received one or more digital objects for compatibility with the digital wallet based on the wallet capability configuration to generate one or more formatted digital objects; and routing, by the processor, the one or more formatted digital objects to the digital wallet according to a routing configuration, wherein the routing configuration uses at least the token identifier for determining the digital wallet as a destination wallet for routing the one or more formatted digital objects.

The method may further include enabling, by the processor, a system administrator to update or edit the routing configuration or the wallet capability configuration through an API interface.

The method may include retrieving, by the processor, a plurality of digital objects associated with the user data using a user's wallet identifier and token identifier; and updating, by the processor, a digital object status of each of the retrieved digital objects.

According to a third aspect of the present disclosure, A digital wallet system for presenting digital objects is provided. The system including: a wallet control interface configured to communicate with a digital object management server; a processor in communication with the wallet control interface, wherein the processor is configured to: receive a push request and a digital object from a router of the digital object management server, wherein the push request includes a token identifier and a digital object identifier, each of which is associated with the digital object; send a request corresponding to a status of the digital object, wherein the request includes at least one of the wallet identifier and the digital object identifier; and send an update corresponding to the status of the digital object, wherein the update includes the digital object identifier and an update concerning the status of the digital object.

Embodiments of the present disclosure may be provided as a network of communicating devices (i.e. a “computerized network”). Embodiments of the present disclosure may be also provided as a software application downloadable into a computer device to facilitate the method. The software application may be a computer program product, which may be stored on a non-transitory computer-readable medium on a tangible data-storage device (such as a storage device of a server, or one within a user device).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure. In the following, embodiments of the present disclosure will be described as non-limiting examples with reference to the accompanying drawings in which:

FIG. 1 is a block diagram showing an overview of the digital object management server networked with digital wallets, issuer interfaces, and administrative controls according to an embodiment of the present disclosure.

FIG. 2 is table showing the various components of user data that are received, stored, edited, and routed by the digital object management server, according to an embodiment of the present disclosure.

FIG. 3 is a block diagram showing an overview of interactions between various digital wallets and the digital object management server via an API interface, according to an embodiment of the present disclosure.

FIG. 4 is a block diagram showing configuration requests from a wallet control interface to the digital object management server, according to an embodiment of the present disclosure.

FIG. 5 is a block diagram showing communications between a wallet control interface and the digital object management server for managing digital object data and status updates, according to an embodiment of the present disclosure.

FIG. 6 is a block diagram showing various communications between the issuer control interface and the digital object management server including uploading, reading, updating, and deleting digital objects, according to an embodiment of the present disclosure.

FIG. 7 is a flowchart showing the processes for managing digital objects within the digital object management system, according to an embodiment of the present disclosure.

FIG. 8 is a is a block diagram showing a technical architecture of a digital object management server according to an embodiment of the present disclosure.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

The term “issuer” is used in a sense which is not necessarily limited to organizations which are legally constituted as banks, since in some jurisdictions other organizations may be permitted to maintain financial accounts such as a payment card account. An issuer may be one of the following: a bank, a financial technology company, a telecommunication company or a financial institution.

The term “digital object” is generally intended to refer to any item of digital content that can be stored, managed, and presented within a digital wallet platform for enhancing user experience. This can include visual elements, interactive content, transactional data, identification data, multimedia, or encrypted data.

As used in this disclosure, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips. . .), optical disks (e.g., compact disk (CD), digital versatile disk (DVD). . .), smart cards, and flash memory devices (e.g., card, stick, key drive. . .).

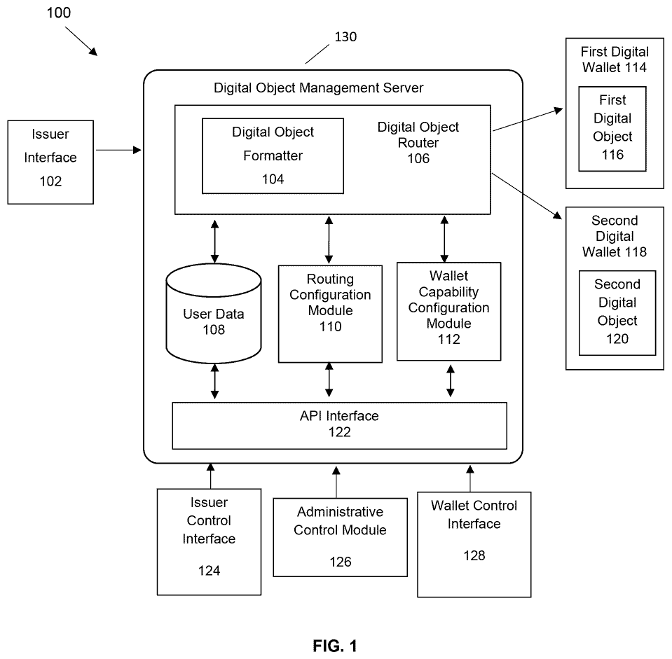

FIG. 1 is a block diagram showing an overview of the digital object network 100 including a digital object management system 130, according to an embodiment of the present disclosure.

As shown in FIG. 1, the network 100 is designed to manage and route digital objects to digital wallets using various modules and interfaces. In network 100, a cardholder may use an issuer interface 102 to upload a digital object (DO), which can be various types of files such as 2D images, videos, sound files, haptic scripts, or interactive scripts. The issuer interface 102 may collect necessary user details from the cardholder, such as a token unique reference (TUR) and a wallet ID (WID) corresponding to the digital object, along with the digital object itself. The information collected through the Issuer Interface 102 is used to begin a tokenization process, where sensitive data is replaced with the TUR such that essential user information is retained without compromising security. After the cardholder uploads user data (e.g. a DO and its associated TUR and WID), the Issuer Interface 102 transmits this user data to the Digital Object Management Server 130 for further processing, such as formatting and routing.

The Digital Object Management Server 130 is a central system responsible for the management, formatting, and routing of digital objects to the appropriate digital wallets. The Digital Object Management Server 130 includes a Digital Object Formatter 104 which takes the digital objects uploaded via the Issuer Interface 102 and formats them according to the specific capabilities of a destination or end user's digital wallet (e.g. first digital wallet 114 and second digital wallet 118). This process helps maintain the usability and integrity of various supported formats of digital objects across diverse digital wallet environments.

The Digital Object Management Server is responsible for the formatting and routing of digital objects to ensure their compatibility with the capabilities of target digital wallets. Initially, during a first-time setup, each digital wallet may be onboarded, establishing a wallet capability configuration as defined in the Wallet Capability Configuration Module 112. Subsequent updates to these configurations can be made contemporaneously, with both formatting and routing operations executed based on the latest settings available on server 130.

The Digital Object Management Server 130 further includes a Digital Object Router 106 which determines the correct routing path for each formatted digital object using a Routing Configuration Module 110. The Router 106 ensures that digital objects are sent to the proper digital wallet based on predefined criteria, such as the Token Unique Reference (TUR) and Wallet ID (WID). The Routing Configuration Module 110 may contain rules and parameters that the Router 106 uses to determine the routing path for each digital object. For example, the routing configuration 110 may contain information such as which digital wallet (identified by the WID) is associated with which token identifier (TUR), and possibly user-specific routing rules that may be based on the user's preferences, location, or other criteria. In example embodiments, the Routing Configuration Module 110 provides wallet-specific configurations, thereby enhancing the server's 130 ability to tailor digital objects to each wallet's user experience requirements. This customization process may use Wallet IDs (WIDs) to implement thematic customizations specific to particular wallets and specifies the types of digital objects to be routed, such as images or videos, under a defined digital object format. Furthermore, the Routing Configuration Module 110 is capable of defining data format types or scripting languages, accommodating formats such as JPEG for images and WAV for audio, as well as scripting languages like JavaScript or PHP for interactive scripts. These configurations ensure that digital objects are compatible and optimized for user experience across different digital wallet platforms.

User Data 108 is a repository within the Digital Object Management Server 130 that stores critical information related to the users and their transactions. This user data 108 may include token identifiers, wallet identifiers, and details of the digital objects associated with each user. The user data 108 supports system 100 in tracking and managing a lifecycle of each digital object.

The Wallet Capability Configuration Module 112 is a component of the Digital Object Management Server 130 that holds information about the various features and formats each digital wallet can support. This module ensures that digital objects are compatible with the specific technological capacities of users'digital wallets, such as the ability to display certain types of images, play videos, or execute interactive scripts.

The API Interface 122 acts as a communication gateway within the Digital Object Management Server 130, allowing external systems and modules, such as issuer applications, administrative controls, and wallet interfaces, to interact with the server. Through this interface, various requests and commands can be received and responses can be sent out, facilitating operations such as the uploading, updating, and retrieval of digital objects, as well as the configuration of wallet capabilities and routing parameters. For example, the API interface 122 can interact with an Issuer Control Module 124 to allow issuers to manage digital objects related to their issued tokens. This includes uploading new digital objects, updating existing ones, or deleting them as needed. The API interface 122 can further interact with an Administrative Control Module 126 to enable system administrators to configure and manage system configurations such as updating the routing configurations corresponding to routing configuration module 110 or modifying wallet capability configurations of module 112.

In managing interactions among different system roles, including issuers, administrators, and digital wallets, the Digital Object Management Server 130 may be configured to process updates sequentially. This approach ensures data integrity and prevents conflicts during concurrent read or update operations by different users. By processing actions sequentially, the server 130 maintains a consistent and reliable data state across all interactions, safeguarding against potential errors or data corruption that could arise from simultaneous modifications.

The API interface 122 can further interact with a wallet control interface 128 of an individual wallet, which may facilitate in the exchange of digital objects and their associated information (TUR, WID, etc) between the server 130 and an individual digital wallet. For example, this interaction may include supporting initialization and updating of wallet configurations, along with pushing of formatted digital objects from the server 130 to wallets. For example, individual digital wallets via their control interface 128 may request the latest versions of digital objects stored in server 130 and provide updates about the format of a digital object or a wallet's capabilities.

First digital wallet 114 and second digital wallet 118 represent applications, services, or digital environments where end-users interact with and view their formatted digital objects (i.e. first digital object 116 and second digital object 120, respectively). First digital object 116 has been specifically formatted via digital object formatter 104 for display and/or interaction with first digital wallet 114. Second digital object 120 has been specifically formatted via digital object formatter 104 for display and/or interaction with second digital wallet 118. The digital objects 116 and 118 may take the form of various multimedia content that users wish to store or digital in their digital wallets including images, videos, interactive scripts, etc.

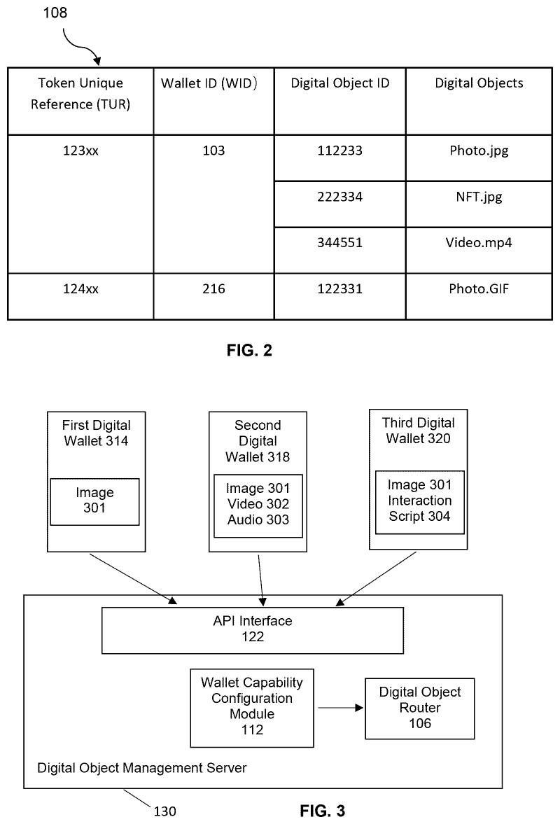

FIG. 2 is table showing the various components of user data 108 that are received, stored, edited, and routed by the digital object management server 130, according to an embodiment of the present disclosure.

As shown in FIG. 2, the Token Unique Reference (TUR) column may correspond to a listing of unique identifiers for payment tokens. The TUR numbers can be used to securely reference payment credentials without exposing sensitive user information. The Wallet ID (WID) column associates each TUR with a specific digital wallet. The WID enables server 130 to associate digital objects with the target wallet or wallets for display or use. The Digital Object Identifier (“Digital Object ID”) column assigns a unique identifier to each digital object managed by server 130, facilitating the tracking, management, and retrieval of each digital object within the server 130. The digital objects column specifies the types of digital objects associated with each TUR and WID combination. The types listed include image files (like .jpg or .GIF) and a video file (.mp4), which could be representations of card art, promotional materials, or other multimedia content for presentation within the digital wallets.

FIG. 3 is a block diagram showing an overview of interactions between various digital wallets 314, 318, and 320 and the digital object management server 130 via an API interface 122, according to an embodiment of the present disclosure.

As shown in FIG. 3, each digital wallet, i.e. first digital wallet 314, second digital wallet 318, and third digital wallet 320, possesses different capabilities for handling different types of digital objects. Each of these digital wallets may transmit their individual capabilities to the API interface of server 130. For example, first digital wallet 314 may indicate to server 130 that it is configured to support basic image content 301, including a baseline capability for visual media. Second digital wallet 318 may communicate to server 130 that it supports a wider range of media types, such as advanced capabilities that include image 301, video 302, and audio files 303. Third digital wallet 320 may communicate to server 130 that it provides interactive functionalities with support for image 301 and interaction scripts 304, such as enhanced user interaction where actions performed in the wallet 320 may trigger specific events or display changes.

The API interface 122 operates as an intermediary that receives the wallet capability data from each digital wallet, and passes the capability data to the wallet capability configuration module 112 which may further process the capability data corresponding to each digital wallet.

Wallet capability configuration module 112 may serve as a database for capability profiles of each wallet, detailing whether a wallet can support images, videos, audio interactive scripts, etc. After receiving the wallet capabilities, configuration module 112 communicates this information to the digital object router 106, which relies on this information to make routing decisions about where to send each digital object to ensure compatibility. The process of adapting the digital objects to fit these capabilities is separately handled by the digital object formatter 104, which tailors the object before they are routed.

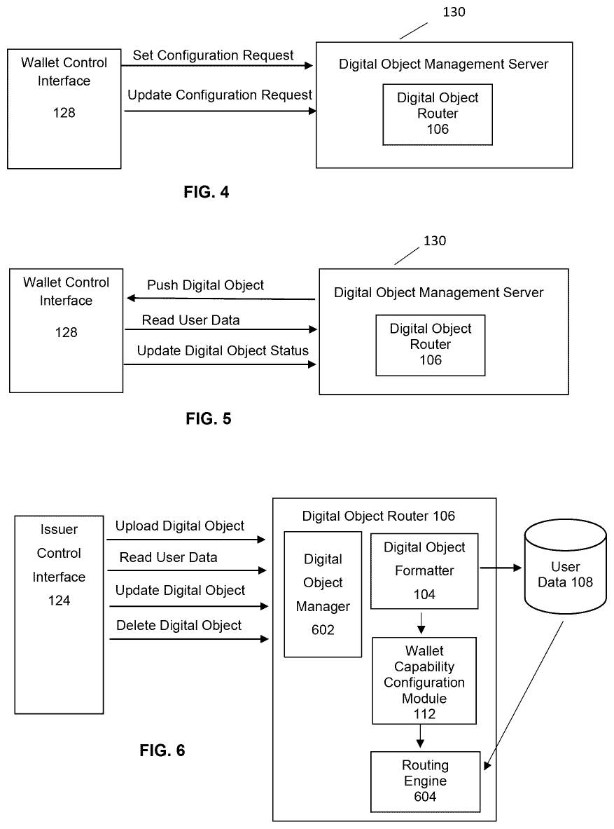

FIG. 4 is a block diagram showing configuration requests from a control interface 128 to the digital object management server 130, according to an embodiment of the present disclosure.

As shown in FIG. 4, wallet control interface 128 of a digital wallet provides a user-facing component that digital wallets use to communicate with the Digital Object Management Server 130. The control interface 128 may send an outbound request (“Set Configuration Request”) to the server 130 for initialization. The outbound request may carry details of the wallet's initial capability configuration, which may include an initial wallet identifier along with its configuration details (such as the types of digital objects that the wallet can process). The Set Configuration Request may be transmitted via the API interface 122 and the server 130 may provide an acknowledgment to the interface 128 regarding the receipt of the Set Configuration Request. Similar to the Set Configuration Request, interface 128, an Update Configuration Request is also an outbound request, but is used for updating the wallet's existing capability configuration. For example, the updated capability data sent by the updated request may include the wallet's identifier and updated wallet configuration details (such as new types of digital objects that the wallet can process).

Although not directly involved in the transfer of the capability configuration data from the set and update configuration requests, the digital object router 106 may rely on the transferred capability configuration information to decide how to route the digital objects stored in server 130 to a target wallet, consistent with the wallet's capabilities.

FIG. 5 is a block diagram showing communications between a wallet control interface and the digital object management server for managing digital object data and status updates, according to an embodiment of the present disclosure.

As shown in FIG. 5, the wallet control interface 128 facilitates the sending and receiving of user data 108 or digital object related data such as digital object statuses. The interface 128 of a digital wallet may process incoming push notifications of digital objects from the server 130, as well as initiate requests to read and update digital object statuses. The digital object management server 130 manages the lifecycle of digital objects, processing the execution of push notifications to the digital wallets, and processing requests from the interface 128 for reading user data and updating digital object statuses. The digital object router 106 facilities the delivery of digital object data such as user data 108 and related digital object statuses to and from the digital wallets as part of the management server 130.

The server 130 may push formatted digital objects along with their associated token identifiers and digital object identifiers through a push notification via API interface 122. The wallet control interface 128 receives this information and validates receipt of the correct content to the server 130.

A read digital object request may be initiated by the wallet control interface 128 to retrieve specific digital object data and its current status from the server. The read request may include information such as the digital object's identifier or its TUR. The server 130 may validate receipt of the read request and provide data about the digital object including its current status.

An update digital object status request may also be initiated by the control interface 128 of the wallet to provide an update to server 130 concerning the status of a digital object. This update request allows the wallet to inform the server 130 about changes to the digital object after user interaction or other events that need to be reflected in the server's records. The update request may include a digital object identifier and its associated status and the server 130 may validate receipt of the update request.

FIG. 6 is a block diagram showing various communications between the issuer control interface and the digital object management server including uploading, reading, updating, and deleting digital objects, according to an embodiment of the present disclosure.

As shown in FIG. 6, the issuer control interface 124 is an interface through which issuers interact with digital object router 106. Issuers via the issuer control interface 124 can perform various operations related to digital objects, such as uploading new content, reading data, updating, and deleting digital objects. The digital object router 106 of the server 130 routes a formatted digital object to their designated digital wallet based on the provided wallet and token identifiers. The digital object formatter 104 formats received digital objects so they are compatible with the capabilities of the destination wallet, as specified by the wallet capability configuration module 112. A digital object manager 602 within the router 106 processes the operations initiated by the issuer control interface 124, such as processing the read, upload, update, and delete requests for digital objects. A routing engine 604 of the router 106 determines an appropriate routing path for the digital objects based on the capabilities and configurations stored in the wallet capability configuration module 112 and the associated formatted digital object stored in the user database 108.

The issuer control interface 124 may send a “upload request” for uploading a new digital object to server 130, including the new digital object's associated wallet identifier and token identifier, indicating where to whom the object should be available. The server 130 in response to the upload request may confirm receipt of the request and the received digital object identifier to the issuer control interface 124. The issuer control interface 124 may send a “read user data” request to the server 130 to request information a specific digital object using a wallet identifier and a token identifier. The server 130 in response of this read user data request may provide data regarding the digital object and its status. The issuer control interface 124 can also send an “update request” to update a digital object, with the digital object identifier indicating the specific digital object to be updated within server 130. The server 130 in response of the update request can confirm receipt of the digital object identifier associated with the update to the issuer control interface 124. The issuer control interface 124 can also send a “delete request” to delete a digital object, with the digital object identifier indicating the specific digital object to be deleted within server. The server 130 in response of the delete request can confirm receipt of the digital object identifier associated with the deletion to the issuer control interface 124.

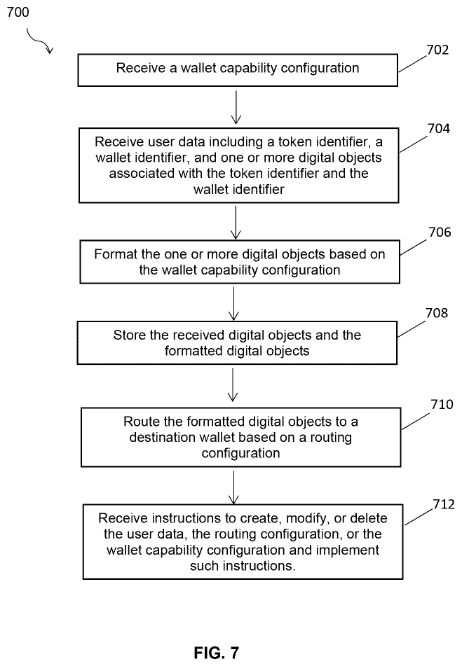

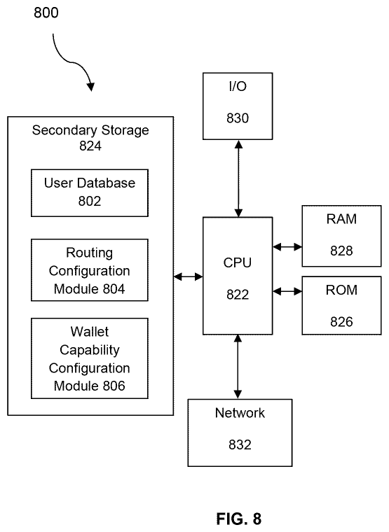

FIG. 7 is a flowchart 700 showing the processes for managing digital objects within the digital object management system, according to an embodiment of the present disclosure. The processing shown in FIG. 7 is carried out in the server 130 shown in FIG. 1

Initially, in step 702, the digital object management server 130 receives a wallet configuration from the wallet capability configuration module 112. In this step, the server 130 acquires information on the types of digital objects a wallet can display or interact with, which is essential to the subsequent formatting and routing of formatted digital objects.

In step 704, user data 108 including a token identifier, a wallet identifier, and one or more digital objects associated with the token identifier and the wallet identifier is received by the digital object management server 130. In this step, the user data 108 may be sent or updated from the wallet control interface 128 of an individual digital wallet to the server 130, via an API interface 122. The user data 108 is received by the API interface 122 of server 130, following requests like “Set Configuration Request” and “Update Configuration Request”initiated by the wallet control interface 128 of a digital wallet.

In step 706, one or more digital objects are formatted using the digital object formatter 104 and based on the wallet configuration information stored on the wallet capability configuration module 112, ensuring that each formatted digital object is compatible with the specific features and capabilities of an intended recipient wallet. The wallet capability configuration module 112 may store data concerning the types of digital objects each wallet can support. For example, wallet 314 of FIG. 3 may only support images, whereas Wallet 318 may support images, videos, and audio.

In step 708, both the received digital objects and formatted digital objects are stored or updated in the user database 108 of management server 130. In this step, the server may archive both the original data objects as received from a source like an issuer or a digital wallet and their formatted versions as tailored for specific wallet capabilities. By maintain these records within user database 108, the server can keep track of all digital objects in their various states and formats for managing a lifecycle of digital content within various digital wallet environments.

In step 710, the formatted digital objects are routed to a destination wallet based on the routing configuration. In this step, the routing configuration provided in the routing configuration module 110 determines where the correctly formatted digital objects should be sent. The routing configuration module 110 may hold rules or protocols for delivering digital objects to various wallets by determining associations between wallet identifiers, token identifiers, and formatted digital objects. The module 110 may contain the necessary logic to direct the flow of digital content within the server 130. Router 106 is informed by the information provided by the routing configuration module 110, and having the formatted object stored from formatter 104, proceeds to send the formatted digital object to its correct destination wallet.

In step 712, the server 130 may receive instructions to create, modify, or delete the user data, the routing configuration, or the wallet capability configuration from a source such as a system administrator or issuer and may execute such instructions. In this step, the server 130 may implement new instructions or data object related information from the issuer control module 124, the administrative control module 126, or the wallet control interface 128. For example, issuers can send instructions to upload new digital objects, read and update existing digital objects, or delete them, as necessary. Moreover, the routing configuration module 110 or the wallet capability configuration module 112 can receive updates based on the instructions for modifying routing paths of digital objects or the capabilities of wallets from interface 124 or control modules 126 and 128. Moreover, the data repository of user data 108 can be updated based on the instructions received and relationships between digital objects, wallet identifiers and token identifiers can be updated accordingly.

FIG. 8 is a is a block diagram showing a technical architecture of a digital object management server 130 according to an embodiment of the present disclosure. Typically, the methods are implemented by a number of computers each having a data-processing unit. The block diagram as shown in FIG. 8 illustrates a technical architecture 800 of a computer which is suitable for implementing one or more embodiments herein.

The technical architecture 800 includes a processor 822 (which may be referred to as a central processor unit or CPU) that is in communication with memory devices including secondary storage 824 (such as disk drives), read only memory (ROM) 826, random access memory (RAM) 828. The processor 822 may be implemented as one or more CPU chips. The technical architecture 820 may further comprise input/output (I/O) devices 830, and network connectivity devices 832.

The secondary storage 824 is typically comprised of one or more disk drives or tape drives and is used for non-volatile storage of data and as an over-flow data storage device if RAM 828 is not large enough to hold all working data. Secondary storage 824 may be used to store programs which are loaded into RAM 828 when such programs are selected for execution. In this embodiment, the secondary storage 824 has a user database 802, routing configuration module 804, and a wallet capability configuration module 806 comprising non-transitory instructions operative by the processor 822 to perform various operations of the method of the present disclosure. As depicted in FIG. 8, the modules 802-806 are distinct modules which perform respective functions implemented by the digital object management server 130. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 802-806 is described herein, these may alternatively be implemented as one or more hardware modules (such as field-programmable gate array(s) or application-specific integrated circuit(s)) comprising circuitry which implements equivalent functionality to that implemented in software. The ROM 826 is used to store instructions and perhaps data which are read during program execution. The secondary storage 824, the RAM 828, and/or the ROM 826 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 832 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 832 may enable the processor 822 to communicate with the Internet or one or more intranets. With such a network connection, it is contemplated that the processor 822 might receive information from the network, or might output information to the network in the course of performing the method operations described herein. Such information, which is often represented as a sequence of instructions to be executed using processor 822, may be received from and outputted to the network, for example, in the form of a computer data signal embodied in a carrier wave.

The processor 822 executes instructions, codes, computer programs, scripts which it accesses from hard disk, floppy disk, optical disk (these various disk-based systems may all be considered secondary storage 824), flash drive, ROM 826, RAM 828, or the network connectivity devices 832. While only one processor 822 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 800, at least one of the CPU 822, the RAM 828, and the ROM 826 are changed, transforming the technical architecture 800 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the disclosure as defined by the claims. Moreover, features of one or more embodiments may be mixed and matched with features of one or more other embodiments.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S. C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A digital object management system comprising: a processor, and a data storage device, the data storage device storing computer program instructions operable to cause the processor to:
receive a wallet capability configuration corresponding to one or more capabilities that are compatible with a digital wallet;
receive user data comprising a token identifier, a wallet identifier, and one or more digital objects associated with the token identifier and the wallet identifier;
format the received one or more digital objects for compatibility with the digital wallet based on the wallet capability configuration to generate one or more formatted digital objects; and
route the one or more formatted digital objects to the digital wallet according to a routing configuration, wherein the routing configuration uses at least the token identifier for determining the digital wallet as a destination wallet for routing the one or more formatted digital objects.

2. The digital object management system according to claim 1, wherein the one or more digital objects comprises at least one of a video file, an image, an audio file, a haptic feedback script, or an interactive script.

3. The digital object management system according to claim 1, wherein the data storage device further stores instructions operable to cause the processor to enable a system administrator to update or modify the routing configuration or the wallet capability configuration through an API interface module.

4. The digital object management system according to claim 1, wherein the data storage device further stores instructions operable to cause the processor to enable a retrieval of a plurality of digital objects associated with the user data based on a user's wallet identifier and token identifier, and to update a digital object status corresponding to each of the retrieved digital objects.

5. The digital object management system according to claim 1, wherein the data storage device further stores instructions operable to cause the processor to receive and store a plurality of digital objects uploaded by a cardholder through an issuer interface, wherein each of the plurality of digital objects is associated with a token identifier, a wallet identifier, and a digital object identifier.

6. The digital object management system according to claim 1, wherein the data storage device further stores instructions operable to cause the processor to dynamically update the routing configuration based on the changes to the one or more features corresponding to the wallet capability configuration.

7. The digital object management system according to claim 1, wherein the wallet capability configuration supports at least one of an image, video, audio, interaction script, or haptic format.

8. The digital object management system according to claim 1, wherein the data storage device further stores instructions operable to cause the processor to receive, from the digital wallet, a set configuration request via an API interface, wherein a wallet identifier and a wallet configuration are requested for initialization by the digital wallet.

9. The digital object management system according to claim 1, wherein the data storage device further stores instructions operable to cause the processor to receive, from the digital wallet, an update configuration request via an API interface, wherein a wallet identifier and a wallet configuration are requested for updating by the digital wallet.

10. The digital object management system according to claim 1, wherein the data storage device further stores instructions operable to cause the processor to receive, from an issuer, a read request via an API interface, wherein a wallet identifier and a token identifier are requested for reading by the issuer.

11. The digital object management system according to claim 1, wherein the data storage device further stores instructions operable to cause the processor to receive, from an issuer, an update request via an API interface, wherein a digital object identifier is requested for updating by the issuer.

12. The digital object management system according to claim 1, wherein the data storage device further stores instructions operable to cause the processor to receive, from an issuer, a delete request via an API interface, wherein a digital object identifier is requested for deletion by the issuer.

13. The digital object management system according to claim 1, wherein the data storage device further stores instructions operable to cause the processor to receive, from an issuer, an upload request via an API interface, wherein a digital object and its corresponding wallet identifier and token identifier are requested for upload by the issuer.

14. The digital object management system according to claim 1, wherein the data storage device further stores instructions operable to cause the processor to execute a push notification via an API interface for pushing the one or more formatted digital objects and associated token identifier to the digital wallet.

15. The digital object management system according to claim 1, wherein the data storage device further stores instructions operable to cause the processor to receive, from the digital wallet, a read request via an API interface for retrieving the digital object and a corresponding digital object status.

16. The digital object management system according to claim 1, wherein the data storage device further stores instructions operable to cause the processor to receive, from the digital wallet, an update request via an API interface, wherein the update request corresponds to an update to a digital object status.

17. A method for managing digital objects, the method comprising:
receiving, by a processor, a wallet capability configuration corresponding to one or more capabilities that are compatible with a digital wallet;
receiving, by the processor, user data comprising a token identifier, a wallet identifier, and one or more digital objects associated with the token identifier and the wallet identifier;
formatting, by the processor, the received one or more digital objects for compatibility with the digital wallet based on the wallet capability configuration to generate one or more formatted digital objects; and
routing, by the processor, the one or more formatted digital objects to the digital wallet according to a routing configuration, wherein the routing configuration uses at least the token identifier for determining the digital wallet as a destination wallet for routing the one or more formatted digital objects.

18. The method of claim 17, further comprising:
enabling, by the processor, a system administrator to update or edit the routing configuration or the wallet capability configuration through an API interface.

19. The method of claim 17, further comprising:
retrieving, by the processor, a plurality of digital objects associated with the user data using a user's wallet identifier and token identifier; and
updating, by the processor, a digital object status of each of the retrieved digital objects.

20. A digital wallet system for presenting digital objects, comprising:
a wallet control interface configured to communicate with a digital object management server;
a processor in communication with the wallet control interface, wherein the processor is configured to:
receive a push request and a digital object from a router of the digital object management server, wherein the push request includes a token identifier and a digital object identifier, each of which is associated with the digital object;
send a request corresponding to a status of the digital object, wherein the request includes at least one of the wallet identifier and the digital object identifier; and
send an update corresponding to the status of the digital object, wherein the update includes the digital object identifier and an update concerning the status of the digital object.
